(19) United States
(12) Patent Application Publication
(10) Pub. No.: US 2014/0078612 A1
(43) Pub. Date: Mar. 20, 2014

(54) METHODS AND DEVICES FOR CONTROLLING HEAD-TO-MEDIA SPACING

(71) Applicants: Neal F. Gunderson, Lake Elmo, MN (US); Lawrence A. Wilcox, Shakopee, MN (US); Richard A. Herr, Chanhassen, MN (US); Scott E. Ryun, Victoria, MN (US); Yufeng Li, San Jose, MN (US); James E. Angelo, Savage, MN (US)

(72) Inventors: Neal F. Gunderson, Lake Elmo, MN (US); Lawrence A. Wilcox, Shakopee, MN (US); Richard A. Herr, Chanhassen, MN (US); Scott E. Ryun, Victoria, MN (US); Yufeng Li, San Jose, MN (US); James E. Angelo, Savage, MN (US)

(21) Appl. No.: 13/615,856

(22) Filed: Sep. 14, 2012

(51) Int. Cl. G11B 21/12

(52) U.S. Cl. 360/75; G9B/21.021

(57) ABSTRACT

In certain embodiments, a method includes calculating a mixing ratio of air internal to a disk drive. In response to the calculated mixing ratio, a head-to-media spacing is adjusted.

In certain embodiments, a system includes a controller that adjusts head-to-media spacing in response to a calculated mixing ratio of air internal to a disk drive.

### SUMMARY

Certain embodiments of the present disclosure are generally directed to methods and devices for controlling head-to-media spacing.

In certain embodiments, a method includes calculating a mixing ratio of air internal to a disk drive. In response to the calculated mixing ratio, a head-to-media spacing is adjusted.

### BRIEF DESCRIPTION OF THE DRAWINGS

FIG. 1 provides a side view of a portion of a read/write head, in accordance with certain embodiments of the present disclosure.

FIG. 2 provides a top view of a disk drive, in accordance with certain embodiments of the present disclosure.

FIG. 3 provides a block diagram, in accordance with certain embodiments of the present disclosure.

FIGS. 4A-B provide side views of a portion of a disc drive in different operating environments, in accordance with certain embodiments of the present disclosure.

FIG. 5 provides a block diagram, in accordance with certain embodiments of the present disclosure.

FIG. 6 provides a block diagram, in accordance with certain embodiments of the present disclosure

### DETAILED DESCRIPTION

The present disclosure relates to devices, systems, and methods for altering head-to-media spacing across a range of operating environments. Certain embodiments include calculating and using a mixing ratio for altering head-to-media spacing—a mixing ratio being a ratio of a mass of water vapor relative to a mass of dry air internal to a disk drive. Certain embodiments include calculating and using an absolute humidity—the mass of water vapor per a volume of a disk drive.

During operation of a data storage device, read/write heads are positioned in close proximity to recording media to write and read data to and from the media. The distance between the head and media can be referred to as head-to-media spacing. Head-to-media spacing typically decreases as data storage devices increase in areal density. That is, as data storage devices store more data bits per disk, devices are typically designed so that read/write heads fly closer to media during operation. Unfortunately, head-to-media spacing is affected as data storage devices operate across a range of environments, for example, different temperatures, humidity, and pressure ranges. And when read/write heads fly too close to recording media, heads can eventually become damaged by coming into contact with the media or particles between the heads and media. Oppositely, when heads fly too high, they cannot accurately read data from the media, among other issues. As such, certain embodiments of the present disclosure are accordingly directed to systems, devices, and methods for controlling head-to-media spacing across a range of environments.

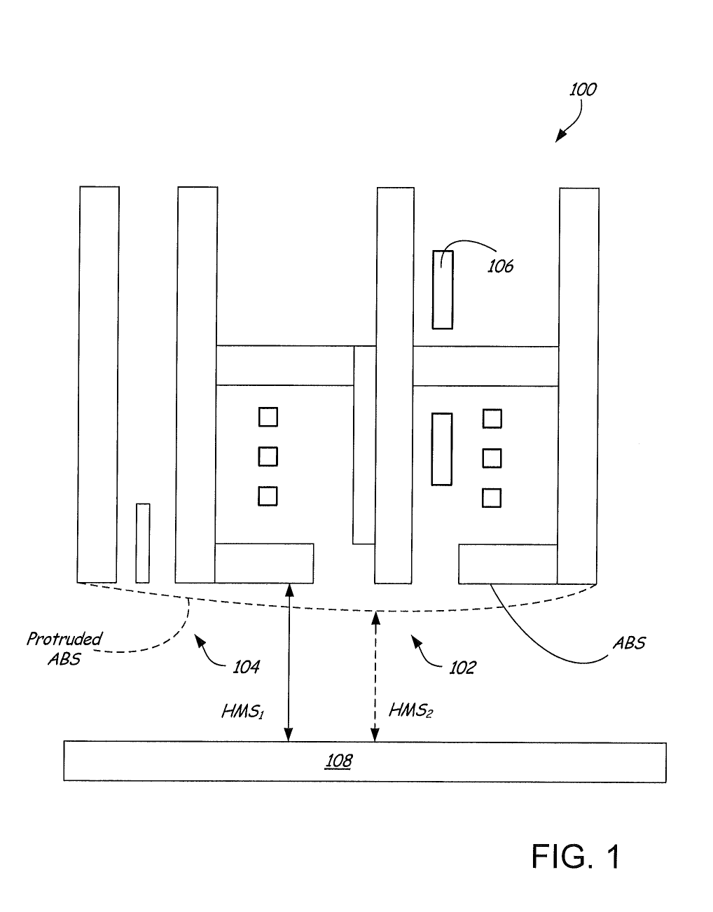

FIG. 1 shows a read/write head 100 having a writer portion 102 and a reader portion 104. The writer portion 102 includes a writer and a coil or set of coils positioned around and/or near the writer. FIG. 1 shows heating circuit 106 positioned near the writer portion 102, but the heating circuit 106 can also be placed near the reader portion 104. Read/write head 100 can include multiple heating circuits positioned near or at both reader and writer portions. When current is passed through the heating circuit 106, the circuit 106 provides localized heat to induce thermal protrusion at an air bearing surface (ABS), As a result of the protrusion, head-to-media spacing can be altered. An example of thermal protrusion is shown as a dotted line in FIG. 1, protruding towards recording media 108. The head-to-media spacing before protrusion is shown as HMS₁ and the post-protrusion head-to-media spacing is shown as HMS₂.

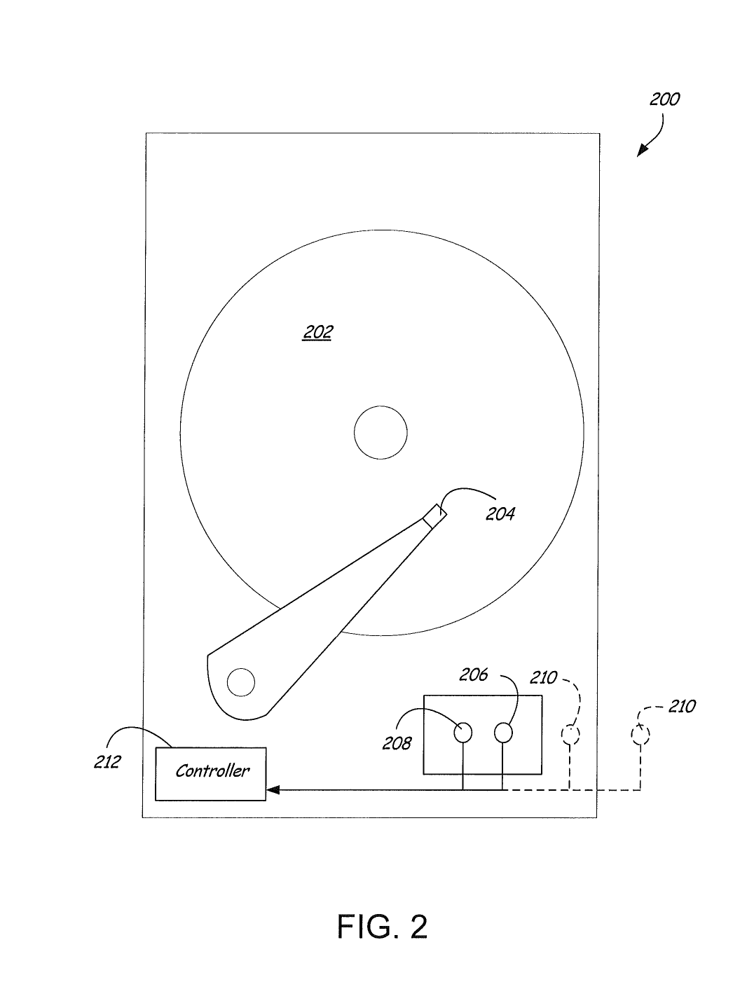

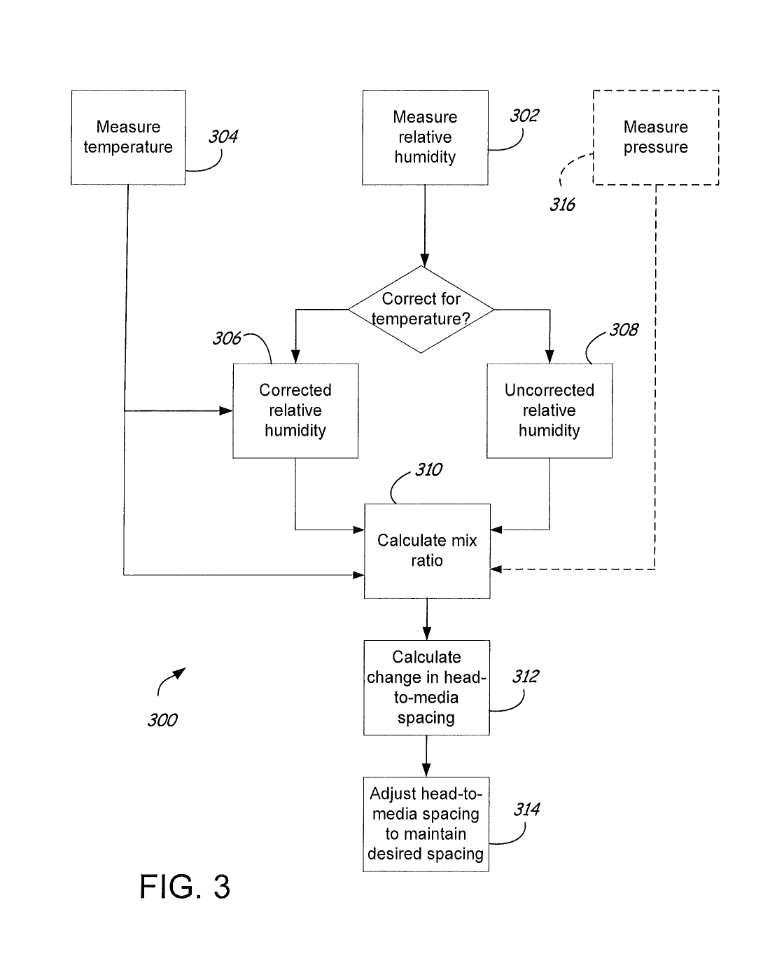

FIG. 2 show a top view of a disk drive 200 including a recording medium 202, head 204, temperature sensor 206, humidity sensor 208, pressure sensor 210, and controller 212. The dimensions and positions of elements within the disk drive 200 are used simply to provide context and can be rearranged if needed. For example, the pressure sensor 210 can be positioned inside or outside the disk drive 200. And for clarity's sake, many disk drive components are not included in the figure. As shown, the temperature sensor 206 and humidity sensor 208 are in close proximity to each other—and possibly within the same sensor package—so that the temperature of air measured by the temperature sensor 206 is close to the temperature of the air at the humidity sensor 208. The sensors are configured to measure the temperature and relative humidity of air internal to the disk drive 200 and can be an analog or digital sensor—the output of which is inputted to the controller 212. As will be discussed with FIG. 3, the measured temperature and relative humidity are used to calculate a mixing ratio of the air internal to the disk drive 200. The calculated mixing ratio is eventually used by the controller 212 to alter head-to-media spacing over a range of operating environments. The pressure sensor 210 can be used to measure air pressure and account for changes in altitude, for example.

FIG. 3 shows a block diagram 300 that includes steps that can be used to calculate a mixing ratio of air internal to a disk drive and, in turn, alter head-to-media spacing. Block 302 represents a step of measuring relative humidity of air internal to a disk drive. A humidity sensor can be utilized to measure relative humidity of the air. The measured relative humidity can be corrected for temperature, meaning that a correction factor (as a function of temperature) may be applied to the measured relative humidity. This correction can account for sensor variations due to temperature changes.

Temperature of air internal to a disk drive can be measured (block 304) by utilizing a temperature sensor like that described with respect to FIG. 2. The measured temperature can be used to correct for the measured relative humidity (block 306). However, it may be unnecessary to correct the humidity for temperature (block 308). The corrected or uncorrected relative humidity along with the measured temperature can be used to calculate a mixing ratio of the air internal to a disk drive (block 310). For example, the mixing ratio can be calculated by controller 212 utilizing methods such as lookup tables or formulas, among other methods. As previously provided, the mixing ratio is a ratio of a mass of water vapor in air relative to a mass of dry air and is typically expressed in grams per kilogram (g/kg). Mixing ratios can be affected by pressure, therefore, certain embodiments can include measuring pressure (block 316) and using the measured pressure as an input to calculate a mixing ratio of the air internal to a disk drive. Doing so can account for changes in altitude.

Applicants have found that head-to-media spacing is affected by the mixing ratio of air internal to a hard drive. As such, after calculating a mixing ratio, a correction factor is calculated and used to maintain a desired head-to-media spacing. The correction factor can be calculated empirically by utilizing a transfer function derived from testing drives in a range of known operating conditions. An average correction factor can be determined and applied to all heads. Or individual correction factors can be utilized for correcting fly height on a head-to-head basis. The transfer function enables a correction factor to be calculated based on a present mixing ratio of air internal to a disk drive (block 312). The correction factor can be calculated, for example, when starting up a disk drive and periodically during operation (e.g., every 60 seconds) so that a desired head-to-media spacing is initiated at startup and maintained during operation (block 314).

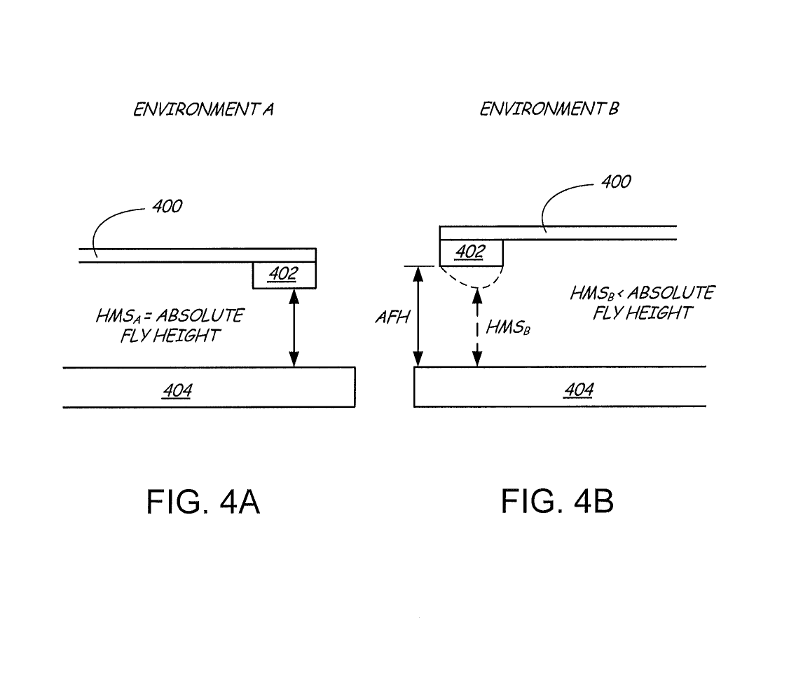

One way to maintain spacing using the correction factor is to utilize a heater in a read/write head. For example, in response to a calculated mixing ratio and resulting correction factor, a heater can induce protrusion of a read/write head to correct for the effect the mixing ratio has on a head's fly height. FIGS. 4A-B show one way the correction factor can be used to maintain a desired head-to-media spacing, however, other methods that alter fly height or head-to-media spacing can be used with the correction factor.

FIGS. 4A-B include an arm 400, read/write head 402, and recording medium 404. As shown in FIG. 4A, the head-to-media spacing (HMS_{A}) is equal to the absolute fly height of the head 402. No correction factor is applied. However, a correction factor is applied in FIG. 4B because environmental conditions have caused the head 402 to increase its fly height. In response, the head 402 is protruded (shown in a dotted line) so that the head-to-media spacing (HMS_{B}) is approximately equal to that in the operating environment in FIG. 4A. The protrusion profile and the difference in fly height are exaggerated so that there is a clear difference between the two figures.

Correction factors can be calculated on an individual head basis and even at different points along a stroke of a head. That is, the mixing ratio may have a different affect on fly height depending on where the head is positioned over a recording medium. For example, a larger correction offset may be needed near an inside diameter of a disk than at an outer diameter of the disk.

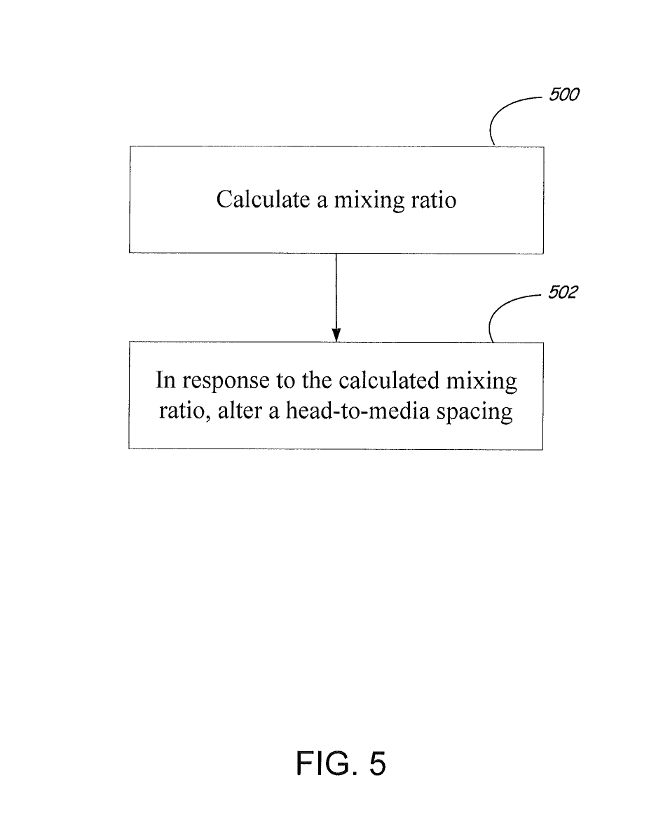

FIG. 5 shows a block diagram of a method in accordance with certain embodiments. Block 500 displays a step that includes calculating a mixing ratio of air internal to a disk drive. Block 502 displays a step that includes altering a head-to-media spacing in response to the calculated mixing ratio.

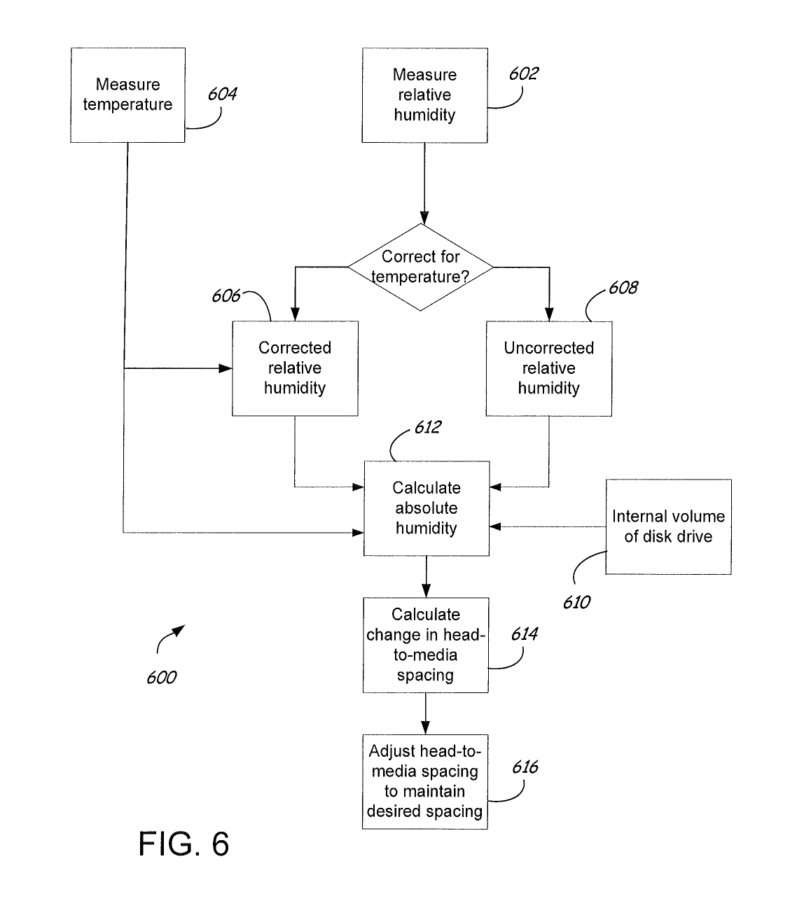

FIG. 6 shows a block diagram 600 that includes steps that can be used to calculate an absolute humidity of air internal to a disk drive and, in turn, alter head-to-media spacing. Block 602 represents a step of measuring relative humidity of air internal to a disk drive. Temperature of air internal to a disk drive can be measured (block 604) and used to correct for the measured relative humidity (block 606). However, it may be unnecessary to correct the humidity for temperature (block 608). The corrected or uncorrected relative humidity along with the measured temperature can be used along with a known internal volume of a disk drive (block 610) to calculate an absolute humidity of the air internal to a disk drive (block 612). For example, the absolute humidity can be calculated by controller 212 utilizing methods such as lookup tables or formulas, among other methods.

Applicants have found that head-to-media spacing is affected by the absolute humidity of air internal to a hard drive. As such, after calculating the absolute humidity, a correction factor is calculated and used to maintain a desired head-to-media spacing. The correction factor can be calculated empirically by utilizing a transfer function derived from testing drives in a range of known operating conditions. The transfer function enables a correction factor to be calculated based on an absolute humidity of air internal to a disk drive (block 614). The correction factor can be calculated, for example, when starting up a disk drive and periodically during operation (e.g., every 60 seconds) so that a desired head-to-media spacing is initiated at startup and maintained during operation (block 616).

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

1. A method comprising:
calculating a mixing ratio of air internal to a disk drive; and
in response to the calculated mixing ratio, adjusting a head-to-media spacing.

2. The method of claim 1, wherein the adjusting step includes adjusting a current through a heater positioned in a head.

3. The method of claim 1, further comprising:
calculating a correction factor, in response to the calculated mixing ratio.

4. The method of claim 1, wherein the mixing ratio is calculated in response to a measured temperature and relative humidity of air internal to the disk drive.

5. The method of claim 4, wherein the mixing ratio is calculated in response to a measured pressure.

6. The method of claim 1, wherein the adjusting step corrects for a change in fly height due to a change in mixing ratio.

7. The method of claim 1, wherein the calculating step occurs during startup of the disk drive.

8. The method of claim 1, wherein the calculating step occurs periodically during operation of the disk drive.

9. The method of claim 8, wherein calculating step occurs every 60 seconds while the disk drive is operating.

10. A system comprising:
a temperature sensor for measuring a temperature of air internal to a disk drive;
a humidity sensor for measuring a relative humidity of air internal to the disk drive; and
a controller configured to adjust a head-to-media spacing in response to a calculated mixing ratio of air internal to a disk drive.

11. The system of claim 10, wherein the mixing ratio is calculated based on the measured temperature and relative humidity.

12. The system of claim 11, further comprising:
a pressure sensor for measuring a environment's pressure, wherein the mixing ratio is further calculated based on the measured pressure.

13. The system of claim 10, further comprising:
a head including a heater, wherein the controller is configured to induce a thermal protrusion in the head to control head-to-media spacing.

14. The system of claim 10, wherein the controller is configured to calculate a correction factor in response to the calculated mixing ratio.

15. The system of claim 14, wherein the controller adjusts head-to-media spacing in response to the calculated correction factor.

16. The system of claim 10, wherein the controller adjusts head-to-media spacing during startup of the system.

17. A method comprising:
calculating an absolute humidity of air internal to a disk drive; and
in response to the calculated absolute humidity, adjusting a head-to-media spacing.

18. The method of claim 17, further comprising:
calculating a correction factor, in response to the calculated absolute humidity.

19. The method of claim 17, wherein the absolute humidity is calculated in response to a measured temperature and relative humidity of air internal to the disk drive along with an internal volume of the disk drive.
